(19) United States
(12) Patent Application Publication
(10) Pub. No.: US 2008/0163710 A1
(43) Pub. Date: Jul. 10, 2008

(54) Double Clutch Gearbox, In Particular For a Motor Vehicle

(76) Inventor: Roumen Antonov, Paris (FR)

Correspondence Address: KENYON & KENYON LLP, ONE BROADWAY, NEW YORK, NY, 10004, US

(21) Appl. No.: 11/663,710

(22) PCT Filed: Sep. 22, 2005
(86) PCT No.: PCT/FR2005/002348

§ 371 Date: Mar. 23, 2007

(30) Foreign Application Priority Data
Sep. 23, 2004 (FR) 0410085

(51) Int. Cl. F16H 3/093; F16H 3/091

(52) U.S. Cl. 74/331

(57) ABSTRACT

The invention concerns a gearbox wherein the clutch shaft (3) selectively drives one or the other of two input shafts (1,2) by means of two clutches (8). The pinion torques defining the successive ratios are configured such that the power is alternately transmitted by one clutch (8) and by the other when the transmission ratios are made to succeed each other sequentially upon use of the gearbox. The input shafts (1,2) are non-coaxial and bear input pinions (E3, E4, E5, E6) which mesh with the same output pinions (S234, S56R). In an improved embodiment, one (1) of the input shafts drives an intermediate shaft (15) which in turn likewise drives the same output pinions (S234, S56R) via the input pinions (E4, E6) borne by said input shaft and operating this time as freely rotating motion transmitter pinions. The invention provides a compact device, and minimization of the number of pinions.

This invention relates to a gearbox, in particular for a motor vehicle, of the type comprising two input shafts, controlled by two clutches serving to select one or the other of the input shafts.

Conventionally, a manual or robotized gearbox comprises a row of pairs of pinions on two shafts. The gear ratio is defined by that of the pairs which is activated by means of a coupling which is typically a synchronizer. As a result of the current trend for gearboxes with at least six gears, these gearboxes become heavy and take up a lot of space in terms of length.

Gearboxes comprising two input shafts exist, in particular for obtaining successive gear shifts while limiting the gap in the transmitted power. For example, an existing gearbox, for motor vehicles, comprises two input shafts which are selected by a double clutch and two output shafts each meshing with the two input shafts via several gear pairs selectively activated by couplings mounted on the two output shafts. Such an arrangement requires a distribution device, allowing the movement to be transmitted to the wheels, no matter which is the active output shaft. This makes the gearbox noticeably heavier. On the other hand, one of the input shafts is tubular and surrounds the other input shaft, which carries its pinions beyond the end of the tubular shaft. This also necessitates the extension of the output shafts so that the central input shaft can engage with the two output shafts; as a result, the gearbox is extended by the same amount, which increases its bulk, its weight and its price. Such a gearbox cannot be installed in a small vehicle.

The object of the invention is to propose a gearbox which is compact and light relative to the number of gears offered.

Another object of the invention is to propose a gearbox with a reduced axial length.

Yet another object of the invention is to propose a double clutch gearbox which satisfies at least one of the above objects.

An additional object is to propose a double clutch gearbox which is easy to install in a four-wheel drive vehicle.

According to the invention, the gearbox device comprising two input clutches allowing one or the other of two input shafts to be selectively coupled to a drive shaft is characterized in that:
the two input shafts are arranged at a distance from one another, each coaxial with one of the input clutches,
the two input clutches each have their own driving element in the axis of the associated input shaft, and
there is a driving linkage between the two driving elements.

According to the invention, it is the input movement which is distributed along two axes in the gearbox. Several improvements are thus made. On the one hand, an input shaft is lighter than an output shaft because it transmits a torque which is not yet multiplied by gear reduction.

On the other hand the concentric shafts which are expensive to produce can be dispensed with. Removing the concentric shafts also removes the reason for extending the previous gearbox, namely that the inner shaft must be extended beyond the tubular shaft and can only carry pinions on the section protruding from the tubular shaft. There may be only one output shaft and this shaft can be relatively short. As will be seen in different embodiments, the couplings can be distributed on several shafts of the gearbox, and the latter, despite being a double clutch gearbox and therefore of a very sophisticated design, is often much shorter than a standard single clutch gearbox.

Other features and advantages of the invention will also become apparent in the following description relating to non-limitative examples.

In the attached drawings:

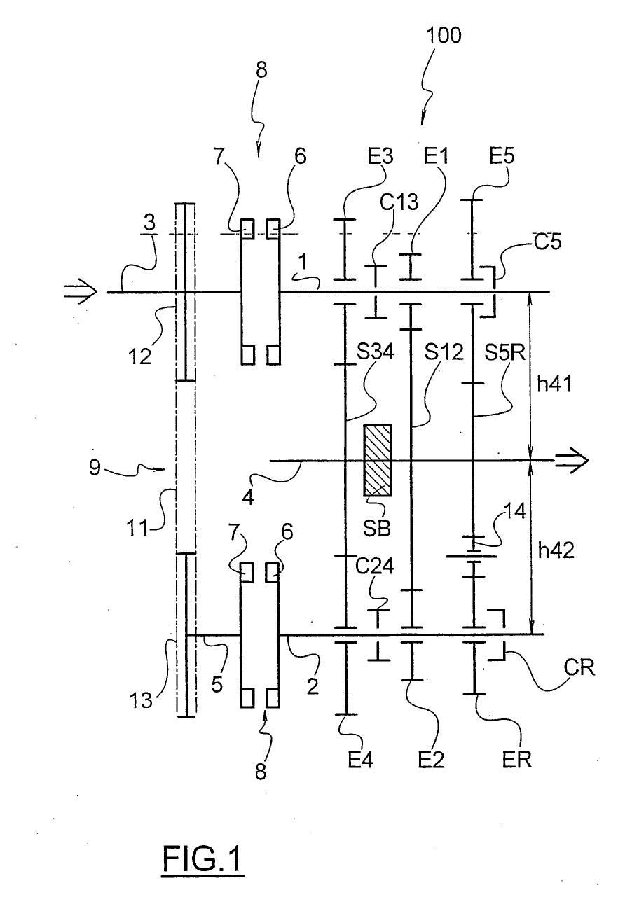

FIG. 1 is a schematic representation of a first embodiment for a gearbox device according to the invention comprising five forward gears and one reverse gear;

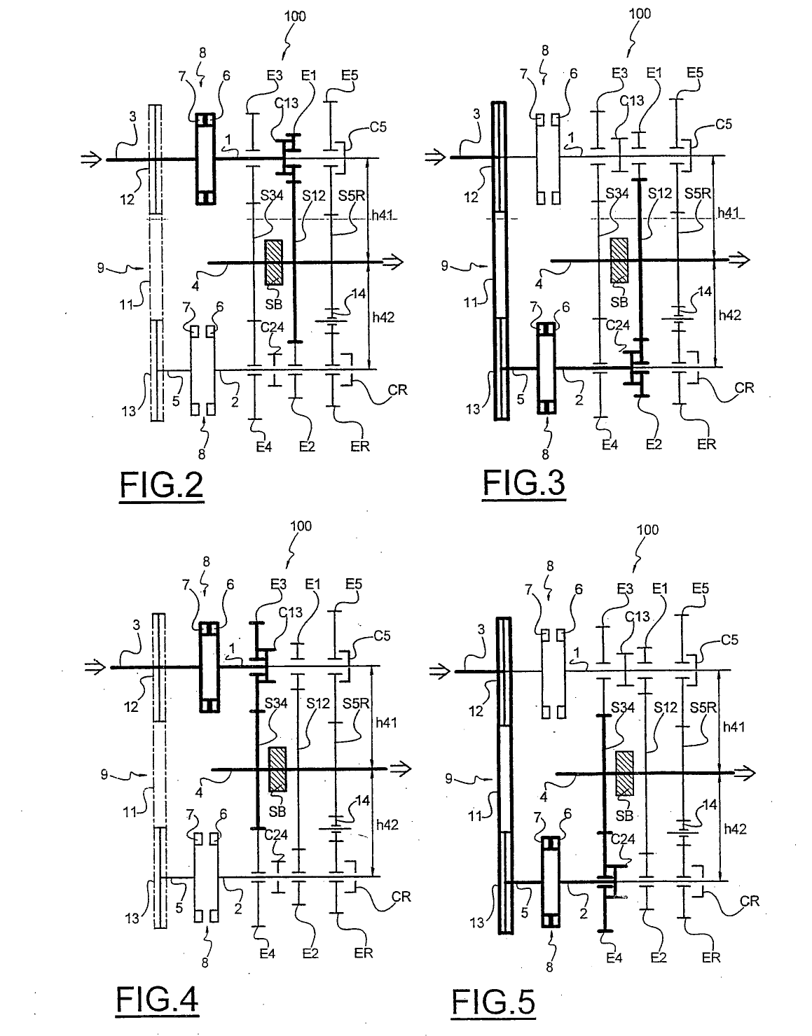

FIGS. 2 to 7 schematically represent the operation of the device of FIG. 1, for each of the gears; and

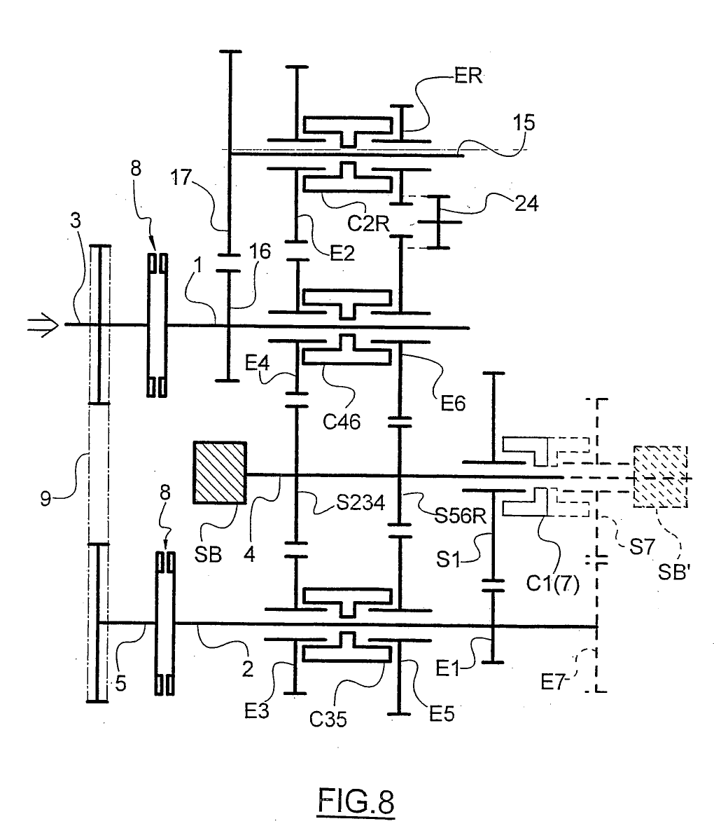

FIG. 8 is a schematic representation of a second embodiment.

FIG. 1 represents a gearbox device 100 comprising two parallel non-coaxial input shafts 1 and 2, namely a first shaft 1 which is coaxial with a drive shaft 3, and a second shaft 2 parallel to the shaft 1 and laterally offset relative to the latter. Each input shaft 1 and 2 is provided with a driven clutch disc 6 with which it is connected for common rotation. The discs 6 are each mounted opposite a driving clutch disc 7. The driving discs 7 are integral one with the drive shaft 3, the other with an intermediate shaft 5 which is coaxial with the second input shaft 2. The drive shaft 3 and the intermediate shaft 5 are connected via a permanent-drive mechanical linkage 9 comprising in this example a driving chain 11 engaging with an input pinion 12 integral with the drive shaft 3 and an intermediate pinion 13 integral with the intermediate shaft 5. In the example represented, the diameter of the intermediate pinion 13 is approximately 1.2 times smaller than the diameter of the pinion 12, so that the intermediate shaft 5 turns approximately 1.2 times faster than the input shaft 3.

The two clutches 8, considered together, can have three states, a first state (represented in FIG. 1), in which the two clutches are disengaged and neither of the discs 6, 7, is in contact with the other, a second state in which the drive shaft 3 is engaged with the first input shaft 1 while the intermediate shaft 5 is disengaged from the second input shaft 2, and a third state in which the drive shaft 3 drives the second input shaft via the intermediate shaft 5 and the associated clutch 8 while being disengaged from the first input shaft 1. The first state allows the uncoupling of the engine relative to the wheels of the vehicle, in particular when the vehicle is stationary and especially just before the vehicle begins to move.

The device 100 also comprises an output shaft 4 mounted for rotation parallel to the input shafts 1, 2. The output shaft 4 is situated operatively and topographically between the input shafts 1 and 2.

The three shafts 1, 2, 4 turn in locations which are fixed in relation to each other in a housing which is not represented. The output shaft 4 has, in relation to the first input shaft 1 a centre distance h41 which is smaller than its centre distance h42 to the second input shaft 2. In the figures, the shafts are represented in the same plane for reasons of clarity. However, in order to limit and adapt the bulk of such a gearbox to the available space, the actual disposition can be “folded” along the axis of the output shaft 4.

Hereafter, the side of the gearbox where the clutches 8 are located, therefore the left side in the representation chosen for the figures will be called “proximal”, and the opposite side, therefore the right side, will be called “distal”.

The output shaft 4 has, from the proximal side to the distal side:
a third and fourth gear output pinion 534 meshing with a third gear input pinion E3 carried by the first input shaft 1, and with a fourth gear input pinion E4 carried by the second input shaft 2;
a first and second gear output pinion S12 meshing with a first gear input pinion E1 carried by the first input shaft 1, and with a second gear input pinion E2 carried by the second input shaft 2;
a fifth gear and reverse gear output pinion S5R meshing on the one hand with a fifth gear input pinion E5 carried by the first input shaft 1, and on the other hand, via an idler gear 14, with a reverse gear input pinion ER carried by the second input shaft 2.

With the solution represented, all the ratio magnitudes can be chosen freely.

The third gear E3 and first gear E1 input pinions are selectively either both rotating freely, independently of each other, on the input shaft 1, or one is coupled to the input shaft 1 and the other is uncoupled from the input shaft 1 by a double coupling C13 mounted between them on the input shaft 1.

The fourth gear E4 and second gear E2 input pinions are selectively either both rotating freely, independently of each other, on the second input shaft 2, or one is coupled to the second shaft 2 and the other is uncoupled from the input shaft 2 by a double coupling C24 mounted between them on the input shaft 2.

The output pinions S34, S12 and S5R are integral in rotation with the output shaft 4.

The input pinion E5 is selectively rotating freely on the first input shaft 1 or coupled to the latter by a coupling C5 mounted on the input shaft 1 on the distal side of the pinion E5.

The input pinion ER is selectively rotating freely on the second input shaft 2 or coupled to the latter by a coupling CR mounted on the input shaft 2 on the distal side of the pinion ER.

A gearbox output pinion SB with helical teeth, integral with the output shaft 4, is mounted in this example between the output pinions S34 and S12 in order to drive, at least indirectly, the input of a differential (not represented) itself driving axle shafts, not represented. But a gearbox output can also be provided at one and/or other of the ends of the output shaft 4.

In FIGS. 2 to 7, illustrating the operation of the device in FIG. 1 for each of the gears, the elements involved in engaging the gear concerned are represented in thick lines.

As illustrated in FIG. 2, in order to obtain the first gear, the first gear input pinion E1 is coupled to the first input shaft 1 by means of the coupling C13 and the drive shaft 3 is engaged with the first input shaft 1. The first gear input pinion therefore drives the first and second gear output pinion S12 and therefore the output shaft 4 on which the latter is fixed. The coupling C5 is in the uncoupled position. The coupling CR can be placed in the position of coupling the input pinion ER with the shaft 2 or the coupling C24 can be placed in the position of coupling the input pinion E2.

In the latter case, the second gear is actually obtained by reversing the states of the input clutches 8 in order to reconnect the drive shaft 3 to the second input shaft 2 via the linkage 9 and the intermediate shaft 5, as shown in FIG. 3. The second gear input pinion E2 therefore drives the first and second gear output pinion S12 and therefore the output shaft 4 on which this pinion is fixed. The coupling C13 can be left in the position of coupling the pinion E1 so that the gearbox is ready to return to first gear, or be placed in the position of coupling the input pinion E3 in order to prepare for the change to third gear.

In the latter case, as illustrated in FIG. 4, the third gear is actually obtained, simply by again reversing the states of the clutches 8 so as to connect the drive shaft 3 to the first input shaft 1. The third gear input pinion E3 therefore drives the third and fourth gear output pinion S34 and therefore the output shaft 4 onto which this pinion is fixed. During this time, the coupling C24 can be left in the position of coupling the pinion E2 in order to prepare the gearbox for returning to second gear by simply reversing the clutches 8, or shift the coupling C24 to the position of coupling the input pinion E4.

In the latter case, as illustrated in FIG. 5, in order to actually obtain fourth gear, the states of the clutches 8 are again reversed so as to connect the drive shaft 3 to the second input shaft 2. The motion is transmitted with an appropriate transmission ratio to the third and fourth gear output pinion S34 by means of the fourth gear input pinion E4. During this time, the coupling C13 can be left in the position of coupling the input pinion E3 in preparation for a return to third gear operation by reversing the clutches 8, or the coupling C13 can be put in the neutral position, i.e. in the position of uncoupling the pinions E1 and E3, and the coupling C5 can be put in the position of coupling the input pinion E5.

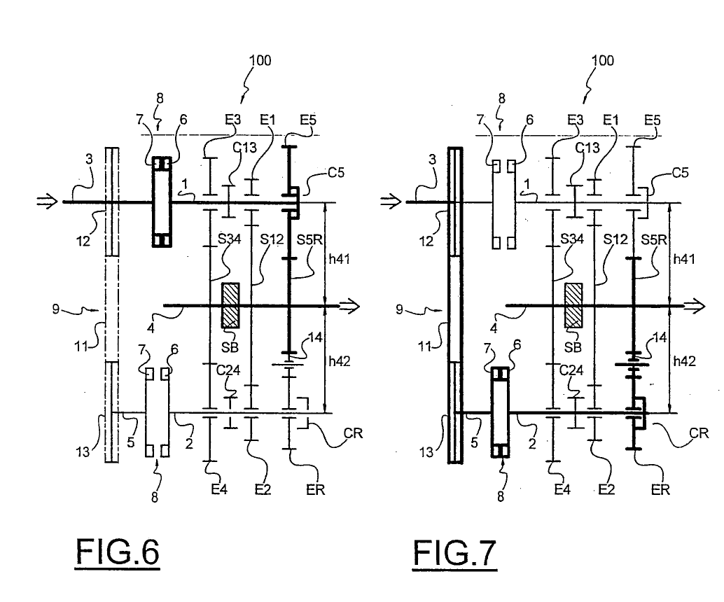

In the latter case, as illustrated in FIG. 6, fifth gear is then obtained, simply by reversing the states of the clutches 8 in order to connect the drive shaft 3 to the first input shaft 1. The fifth gear input pinion E5, integral with the first input shaft 1, therefore drives the fifth gear and reverse gear output pinion S5R and therefore the output shaft 4 of which it forms an integral part. During this time, the coupling C24 can be left in the position of coupling the input pinion E4 in order to prepare for a return to fourth gear operation by reversing the state of the clutches 8.

Returning to the situation of first gear operation, where, according to the above-mentioned possibility the coupling CR is placed in the position of coupling the reverse gear input pinion ER, reverse gear is then obtained by reversing the state of the clutches 8 in order to connect the drive shaft 3 to the second input shaft 2. The input pinion ER, fixed onto the second input shaft 2, therefore drives the fifth gear and reverse gear output pinion S5R via the idler gear 14, and therefore drives the output shaft 4 in the reverse direction. The presence of the idler gear 14 between the pinions ER and S5R results in a reduction in the diameter of the pinion ER and therefore an appropriate gear reduction of the reverse gear. During this time, the coupling C13 can be left in the position of coupling the input pinion E1 to the input shaft 1, in preparation for a return to first gear operation by reversing the state of the clutches 8.

The axial length of the gearbox is very small considering its number of gears. The number of pinions is also reduced because each of the three output pinions S12, S34, S5R is active for two different gears. Three out of five forward gears involve only one meshing, the two others involve the linkage 9 followed by one meshing, which makes an average of clearly less than 2, which is remarkable for a double clutch gearbox and would even be excellent for a standard single clutch gearbox.

With the two input shafts remaining independent, the device comprises, as has been seen, six successive gear ratios, from reverse gear to the fifth forward gear, of which one gear is always obtained by clutching a different input shaft from the shaft used to obtain the gear ratio immediately next to it. Thus, when shifting to the next gear up it is possible to prepare the second gear while using the first gear, to prepare the third gear while using the second gear, to prepare the fourth gear while using the third gear and to prepare the fifth gear while using the fourth gear. Thus it is necessary only to reverse the states of the clutches 8 in order to shift up from one gear to the one immediately above it. For these gears this enables the gearshift to be rapid and flexible with an imperceptible power gap. The same is true of a downward gearshift. The gear which is prepared but not activated turns the input shaft 1 or 2 which is unclutched at a speed different to that of the engine 3, but this is not disadvantageous. All the gears are obtained by placing just one coupling in the coupling position.

Typically, the control of the gearbox is robotized, partially or totally. The reversal of the clutches 8 is carried out by controlled actuators. It is thus possible to prevent any interruption of the power transmission, because one clutch 8 can begin to “take” when the other is not yet totally disengaged. This is impossible in the state of the art whereby a single mobile disc moves from one fixed disc to another.

The embodiment in FIG. 8 will be described only with regard to its differences in relation to that in FIGS. 1 to 7.

The output shaft 4 has, from its proximal end to its distal end, the following elements:
a second, third and fourth gear output pinion S234 meshing with a third gear input pinion E3 carried by the second input shaft 2, and with a fourth gear input pinion E4 carried by the first input shaft 1;
a fifth and sixth and reverse gear output pinion S56R, meshing with a second gear input pinion E5 carried by the second input shaft 2, and with a sixth gear input pinion E6 carried by the first input shaft 1;
a first gear output pinion S1 meshing with a first gear input pinion E1 integral with the second input shaft 2; and
in the option represented in dotted lines a seventh gear output pinion S7 meshing with a seventh gear input pinion E7, also optional, integral with the second input shaft 2.

In the embodiment represented in FIG. 8, and irrespective of the other modifications that it has in comparison to FIG. 1, the output shaft 4 has an output pinion SB at its proximal end and optionally another SB′ at its distal end. It is also possible only to fit the pinion SB′. It is advantageous to fit two output pinions because one can drive the front wheels and the other the rear wheels of a four-wheel drive vehicle.

The first input shaft 1 is placed operatively between the output shaft 4 and an intermediate shaft 15. The intermediate shaft 15 is coupled in a permanent way to the first input shaft 1 via a pair of pinions 16, 17. In the configuration represented, pinion 16 integral with the input shaft 1 has a smaller number of teeth than pinion 17 integral with the intermediate shaft 15, which consequently rotates slower than the input shaft 1. In its turn the linkage 9, although here too it's a question of choice of dimensions, establishes a 1:1 ratio between input shafts 1 and 2.

The fourth gear input pinion E4 meshes with a second gear input pinion E2 carried by the intermediate shaft 15.

The sixth gear input pinion E6 is in meshing relationship with a reverse gear input pinion ER carried by the intermediate shaft 15. The above-mentioned meshing relationship is achieved via a reversing gear 24 mounted for free rotation in the gearbox housing, not shown. The offset position in which the gear 24 is shown means that its axis is located behind or in front of the common plane of the axes of the first input shaft 1 and the intermediate shaft 15.

A coupling C2R couples one or other of the input pinions E2 and ER, or neither of them, to the intermediate shaft 15.

A coupling C46 couples one or other of the input pinions E4 and E6, or neither of them, to the input shaft 1.

A coupling C35 couples one or other of the input pinions E3 and E5, or neither of them, to the input shaft 2.

A coupling C1(7) couples one or other of the input pinions S1 and S7, if fitted, or neither of them, to the output shaft 4.

The pinions S234 and S56R are integral with the output shaft 4.

In order to obtain the reverse gear, the reverse gear input pinion ER is coupled to the intermediate shaft 15 by means of the coupling C2R and the drive shaft 3 is clutched to the first input shaft 1. The input pinion ER, driven by the shaft 3 via the pair of pinions 16, 17 and the shaft 15, drives the output pinion S56R via the idler gear 24 and the input pinion E6 forming an idling intermediate pinion on the first input shaft 1 because the coupling C46 is in the uncoupled state of the two pinions E4 and E6. During this time, the coupling C1(7) can be placed in the position of coupling the output pinion S1 to the output shaft 4. When this is done, the first gear ratio is actually obtained by reversing the states of the input clutches 8 in order to connect the drive shaft 3 to the second input shaft 2 via the linkage 9 and the intermediate shaft 5. The first gear input pinion E1 drives the first gear output pinion S1 and therefore the output shaft 4 to which this pinion is coupled. The coupling C2R can be left in the position of coupling the pinion ER so that the gearbox is ready to return to reverse gear, or be placed in the position of coupling the second gear input pinion E2 in order to prepare for the change to second gear.

In the latter case, the second gear is actually obtained simply by again reversing the states of the clutches 8 in order to engage the drive shaft 3 with the first input shaft 1. The second gear input pinion E2 therefore drives the second, third and fourth gear output pinion S234, and therefore the output shaft 4 on which this latter pinion is fixed. The transfer of motion from the pinion E2 to the output pinion 5234 is achieved via the fourth gear input pinion E4 which turns freely on the first input shaft 1 because the coupling C46 is still in its uncoupled state of the two input pinions E4 and E6 in relation to the first input shaft 1. As a result, it is now the input pinion E4 which transfers the motion between the second gear input pinion E2 and the output shaft 4.

During this time, the coupling C1(7) can be left in the position of coupling the output pinion S1 in order to prepare for a return to the first gear, or this coupling can be placed in the uncoupling position and the coupling C35 can be shifted into the coupling position of the third gear input pinion E3 in order to prepare for the change to third gear operation.

The operations and changes to third, fourth, fifth and sixth gear will not be described in detail because they are very similar to the operations in first, second, third and fourth gear of the embodiment shown in FIG. 1. When the gearbox operates in its sixth gear, the coupling C35 can be left in the position of coupling the fifth gear input pinion E5 to the second input shaft 2 in order to prepare for a return to the operation in the fifth gear, or on the other hand the coupling C35 can be changed to the uncoupled state and, if pinions E7 and S7 are fitted, the coupling C1(7) can change to the position of coupling the seventh gear output pinion S7 to the output shaft 4 in order to prepare for a change to operation in seventh gear, which is then achieved simply by reversing the states of the clutches 8 in order to deactivate the first input shaft 1 and activate the second input shaft 2.

In this embodiment, the gearbox is particularly compact, two of the output pinions each operate three different gear ratios, but despite this all the gear-ratio magnitudes can be chosen independently of each other and the space occupied is extremely small, as is the total number of pinions in the gearbox. This is possible due to the special role played by the input pinions E4 and E6 which can either serve as a pinion coupled to a power transmission shaft to establish by their number of teeth a given gear ratio, or they can be uncoupled from this shaft and serve simply as intermediate pinions between the input pinions E2 and ER, carried by the intermediate shaft 15, and the output shaft 4.

Of course, the invention is not limited to the examples which have been described and represented.

In the example of FIG. 8, it would be possible to provide another intermediate shaft such as 15 coupled in a permanent way to the second input shaft 2. The first gear E1 and seventh gear input pinions E7 could be carried by the first input shaft 1.

In the two embodiments, the permanent linkage 9 can be realized by a cascade of pinions and not by a chain.

Three input shafts could also be provided, each having their own clutch and driven by a permanent common linkage such as the chain linkage 9.

In the embodiment of FIG. 8, it is possible to obtain a spatially advantageous arrangement by folding the diagram along the axis of the first input shaft 1 and/or along the axis of the output shaft 4, at will depending on the desired installation.

1-9. (canceled)

10. A gearbox device comprising two input clutches (8) allowing one or the other of two input shafts (1, 2) to be selectively coupled to a drive shaft (3), characterized in that:
the two input shafts (1, 2) are arranged at a distance from one another each another, each coaxial with one of the input clutches (8),
the two input clutches (8) each have their own driving element (7) in the axis of the associated input shaft (1, 2), and
there is a driving linkage (9) between the two driving elements (7).

11. A device according to claim 10, characterized in that the driving linkage (9) is mechanical.

12. A device according to claim 11, characterized in that the driving linkage comprises a chain (11).

13. A device according to claim 11, characterized in that the driving linkage (9) comprises a cascade of pinions.

14. A device according to claim 13, characterized in that one of the input clutches (8) is coaxial with the drive shaft (3), the other input clutch has it axis at a distance from the drive shaft (3).

15. A device according to claim 14, characterized in that there is a gear ratio other than 1:1 in the driving linkage (9).

16. A device according to claim 15, characterized in that at least one output pinion (S34; S12; S234, S56R) meshes with two input pinions (E3 and E4, E1 and E2; E4 and E3, E6 and E5) each carried by one of the input shafts (1, 2) and being able to be selectively connected to the associated input shaft by a coupling (C13, C24, C46, C35).

17. A device according to claim 10 to 16, characterized in that:
at least one input pinion (E4, E6) carried by a first one (1) of the input shafts can be selectively coupled to the first input shaft (1) and mesh with an output pinion (S234, S56R).
the first input shaft (1), via a linkage (16, 17) which is independent of this input pinion (E4, E6), drives a pinion (E2, ER), carried by an intermediate shaft (15) and meshing with said input pinion (E4, E6).

18. A device according to claim 17, characterized in that at least one output pinion (S234, S56R) transmits the power for three different gear ratios.
